(19) United States
(12) Patent Application Publication
(10) Pub. No.: US 2014/0331407 A1
(43) Pub. Date: Nov. 13, 2014

(54) PATIENT SUPPORT APPARATUS

(71) Applicant: SIEMENS AKTIENGESELLSCHAFT, MUNCHEN (DE)

(72) Inventor: Patrick Gross, Ismaning (DE)

(73) Assignee: SIEMENS AKTIENGESELLSCHAFT, MUNCHEN (DE)

(21) Appl. No.: 14/254,002

(22) Filed: Apr. 16, 2014

(30) Foreign Application Priority Data
May 8, 2013 (DE) 102013208477.3

(51) Int. Cl. A61G 13/00; A47C 27/08

(52) U.S. Cl. CPC A61G 13/00; A47C 27/083; A47C 27/081
USPC 5/601; 5/690; 5/706

(57) ABSTRACT

A patient support apparatus for supporting a patient on an examination table is provided. The patient support apparatus includes at least one chamber having at least one opening for supplying a filler, a connection unit for connecting the at least one chamber to a regulating unit, and the regulating unit for regulating a quantity of the filler within the at least one chamber. In an embodiment, the patient support apparatus has a pressure sensor for capturing a sensor value of a pressure, and a processing unit which is so designed as to compare the sensor value with a threshold value.

### CROSS REFERENCE TO RELATED APPLICATIONS

The present application claims priority to German application No. 10 2013 208477.3 DE filed May 8, 2013, the entire content of which is hereby incorporated herein by reference.

### FIELD OF INVENTION

The present invention relates to a patient support apparatus for supporting a patient on an examination table.

### BACKGROUND OF INVENTION

Conventional patient support apparatuses are used in the field of medical technology, particularly in the field of imaging procedures. In this case, at the end of the imaging examination in particular, it is necessary for the patient to return from a prone position on a patient bed to an upright position. In the case of older patients in particular, this is not usually possible without assistance.

In practice, handles on the side of the patient bed are often used in this case, allowing the patient to sit up, or at least one further person provides assistance for this purpose.

SUMMARY OF INVENTION

The object of the invention is to provide a patient support apparatus for supporting a patient during a medical imaging examination by means of a medical imaging device, wherein said apparatus makes it easier for a patient to sit up after the medical imaging.

This object is achieved by a patient support apparatus according to claim 1 and a medical imaging device according to claim 15. Advantageous developments of the invention are specified in the subclaims appended respectively thereto.

The invention exploits the possibility of supplying a filler via an opening into a patient support apparatus comprising at least one chamber, and regulating a quantity of the filler within the chamber via a regulating unit such that a patient lying on the patient support apparatus is raised into an upright position. This makes it considerably easier for the patient to stand up. The at least one chamber is preferably arranged in the region of a rest for the upper body of the patient in this case, such that a change in the volume of the chamber, in particular an increase in the volume, assists the patient in the act of standing up.

In this case, a patient support apparatus is provided for supporting a patient on an examination table, wherein the patient support apparatus comprises at least one chamber having at least one opening for supplying a filler, a connection unit for connecting the at least one chamber to a regulating unit, and the regulating unit for regulating a quantity of the filler within the at least one chamber. A chamber can take the form of, for example but not exclusively, an elastic airtight material such as e.g. polyvinyl chloride or gum resin. A chamber comprises a hollow space which fills up over time as a filler is supplied. A filler can take the form of, for example but not exclusively, one or more solids such as e.g. polystyrene balls, a gel, a gas mixture or a liquid. The connection unit comprises, for example but not exclusively, a hose, a pipe or other line by means of which the filler of the regulating unit can be supplied.

The patient support apparatus itself is so embodied as to have, for example but not exclusively, the shape of a wedge, such that as a result of supplying a filler into the chambers while a patient is supported on the patient support apparatus, the patient can be raised into an upright position with ease if the chamber is used as a rest for the upper body of the patient. This makes it significantly easier for the patient to stand up, e.g. after the examination is complete.

In a preferred embodiment variant, the filler comprises at least a gas and/or gas mixture. A filler in a gaseous state of matter can be supplied to and removed from the patient support apparatus with particular ease. Such a filler is also particularly inexpensive, particularly if the gas mixture contains air.

In an advantageous development, the regulating unit has a pump for supplying the filler. It is thus easy to supply the filler to the patient support apparatus and particularly easy to regulate a pressure and/or a shape of the chamber.

In a further development, the chamber comprises a discharge valve for discharging the filler, in order to remove an excess of the filler or to drain the filler completely from the patient support apparatus.

In an embodiment according to the invention, the chamber comprises at least in part an elastic covering. This allows the surface of the patient support apparatus to adapt specifically to the quantity of filler that is introduced, thereby offering the patient an ergonomic resting surface whose resistance can be adapted, according to the filling pressure within the patient support apparatus, to individual needs of the patient or specific requirements of an examination.

In a preferred embodiment variant, the patient support apparatus has an equalization container for fillers, and the chamber has an interface by means of which said chamber is attached to the equalization container. The filler can therefore be displaced further under load, i.e. by escaping into the equalization container, and can be supplied back to the chamber particularly quickly when the load on the chamber is reduced.

In an advantageous development, the equalization container for fillers is equipped with a spring-loaded piston. A spring-loaded piston comprises a mobile element, the spring, and a fixed element, the equalization container, wherein said elements together form an enclosed hollow space whose volume can be altered. In this way, the size of the equalization container can be smaller than that of an equalization container which does not have such a spring-loaded piston.

In a further development, the patient support apparatus comprises at least two chambers, which are so arranged as to be mutually independent or interconnected. The interconnected arrangement is effected inter alia but not exclusively via pressure intensifiers. Such arrangements allow the patient to be supported more comfortably, since the different chambers are able to counteract different pressure loads from the patient. For example, a load resulting from the trunk of the patient will displace a larger quantity of the filler from one chamber than will be displaced from another chamber by a concurrent load resulting from extremities of the patient on this other chamber.

In a preferred embodiment variant, the patient support apparatus comprises a pressure sensor for capturing a sensor value of a pressure. It is therefore possible to determine the current pressure value within the chamber of the patient support apparatus and to adjust a position which is advantageous for an examination or comfortable for a patient, for example.

In an advantageous development, the patient support apparatus comprises a shape sensor for capturing a sensor value of a geometric shape of the chamber. It is therefore possible to capture the actual geometric state of the patient support apparatus and likewise to adjust a position which is advantageous for an examination or comfortable for a patient, for example.

In a further development, the patient support apparatus comprises a processing unit which is so designed as to compare the sensor value with a threshold value. It is thus possible to determine whether a measured sensor value, i.e. an actual state, corresponds to a predefined sensor value, i.e. a threshold value. The processing unit itself comprises an arithmetic unit or a programmable control and a memory unit. It is therefore possible to identify and avoid those positions of the sections of the patient support apparatus which are unfavorable for the patient. This offers increased safety for the patient.

In an embodiment according to the invention, the processing unit is so configured as to trigger a safety mode if the threshold value is exceeded. If a measured sensor value, i.e. an actual state, exceeds a predefined sensor value, i.e. a threshold value, the triggering of a safety mode such as e.g. an alarm or an operational stoppage of the patient support apparatus provides an additional safety for the patient being examined and the medical personnel involved in the examination of the patient. For example, the safety mode may be triggered if the volume of the chamber during the examination changes to the extent that the change in the volume is greater than a predefined maximal tolerable volume change.

In a preferred embodiment variant, the safety mode can disable a mobile mode of the patient support apparatus and/or change an operating mode of the patient support apparatus 1. If a measured sensor value, i.e. an actual state, exceeds a predefined sensor value, i.e. a threshold value, it may be necessary to discharge the filler from the patient support apparatus immediately, e.g. if the patient support apparatus assumes a shape which would endanger the patient. Disabling the mobile mode of the patient support apparatus prevents any further change to the shape of the patient support apparatus, e.g. any further supply of a filler, and therefore serves to increase the safety of the patient support apparatus. A change in the operating mode of the patient support apparatus causes e.g. an immediate discharge of the filler in the patient support apparatus, and therefore e.g. a return to the initial state of the patient support apparatus, and likewise allows greater safety of the patient support apparatus.

In an advantageous development, the chamber is adapted to a shape of a bed surface of the examination table, i.e. the bed surface of the examination table has a specific shape, while the chamber of the patient support apparatus has a corresponding or compatible shape. The bed surface may have a concave shape, for example, while the chamber of the patient support apparatus has a convex external shape which is compatible therewith. It is thus possible to achieve a better fit of the patient support apparatus relative to the bed surface used during an examination, thereby avoiding unevenness, air pockets, etc. The patient support apparatus can also be directly adapted to a multiplicity of existing bed surfaces in this way, e.g. patient beds of medical imaging devices, such that use of the patient support apparatus is not limited in the context of a medical examination using older devices.

In the context of the present invention, provision is further made for a medical imaging device which comprises the claimed patient support apparatus, in particular a magnetic resonance device, a computer tomography device, or other device which can be used for further imaging procedures. The advantages of the medical imaging device according to the invention correspond essentially to the advantages of the patient support apparatus according to the invention, these being explained in detail above and therefore not repeated here.

### BRIEF DESCRIPTION OF THE DRAWINGS

The invention is described and explained in greater detail below with reference to the exemplary embodiments illustrated in the figures, in which:

FIG. 1 shows a patient support apparatus according to the invention, and

FIG. 2 shows a medical imaging device comprising a patient support apparatus according to the invention.

### DETAILED DESCRIPTION OF INVENTION

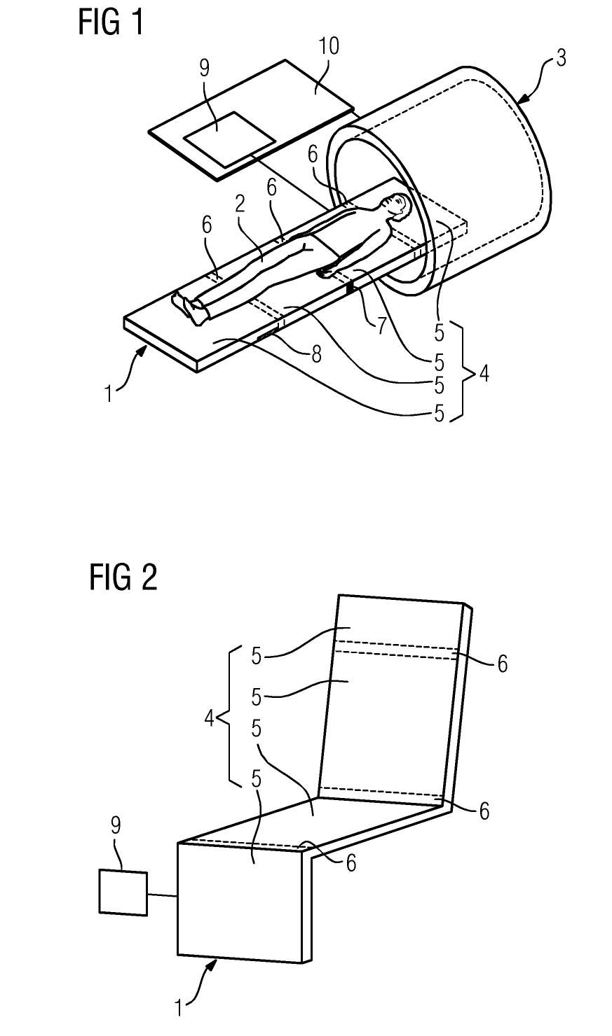

FIG. 1 shows a patient support apparatus 1 according to the invention for supporting a patient 2 on an examination table 3. The patient support apparatus 1 has four chambers 4 and an opening 5 for supplying a filler, a connection unit 6 for connecting the four chambers 4 to a regulating unit 7, and the regulating unit 7 for regulating a quantity of the filler within the four chambers 4. The filler comprises a gas mixture in this case. The patient support apparatus 1 itself is so embodied here as to have the shape of a wedge, such that as a result of supplying a filler into the chambers 4 while a patient 2 is supported on the patient support apparatus 1, the patient 2 can be raised into an upright position with ease if the upper body of the patient 2 is supported on the patient support apparatus 1. The connection unit 6 comprises e.g. a hose, a pipe or other line by means of which the filler of the regulating unit 7 can be supplied.

The regulating unit 7 also has a pump 8 for supplying the gas mixture, and one of the chambers 4 itself comprises a discharge valve 9 for discharging the gas mixture. The chambers 4 have an elastic covering 10 and are so arranged as to be interconnected. The interconnected arrangement is effected e.g. via pressure intensifiers. Such arrangements allow the patient 2 to be supported more comfortably, since the different chambers 4 are able to counteract different pressure loads from the patient 2. For example, a load resulting from the trunk of the patient 2 will displace a larger quantity of the filler from one chamber 4 than will be displaced from another chamber 4 by a concurrent load resulting from extremities of the patient 2 on this other chamber 4. In the case of the interconnected arrangement, shared openings 5 and discharge valves 9 are used for the chambers 4. However, the chambers 4 can also be so arranged as to be mutually independent, such that the gas mixture cannot distribute itself within different chambers 4. In this arrangement, each chamber 4 must however have a separate opening 5 and a separate discharge valve 9.

The patient support apparatus 1 further comprises an equalization container 11 for gas mixtures, and one of the chambers 4 has an interface 12 by means of which the chambers 4 are attached to the equalization container 11. The equalization container 11 itself is equipped with a spring-loaded piston 19. The gas mixture can therefore be displaced under load, i.e. by moving into the equalization container 11. By virtue of the spring-loaded piston 19, the size of the equalization container 11 can be smaller than that of an equalization container 11 which does not have such a spring-loaded piston 19.

The patient support apparatus 1 further comprises a pressure sensor 13 for capturing a sensor value of a pressure of the chambers 4, and a shape sensor 14 for capturing a sensor value of a geometric shape of the chambers 4. The pressure sensor 13 allows the current pressure value within the patient support apparatus 1 to be determined, and a position which is advantageous for an examination or comfortable for a patient 2 can be adjusted. The shape sensor 14 allows the actual geometric state of the patient support apparatus 1 to be captured, and a position which is advantageous for an examination or comfortable for a patient 2 can likewise be adjusted. The adjustment of the pressure and/or the shape of the chambers 4 is effected by means of a processing unit 15 of the patient support apparatus 1 and the regulating unit 7.

The processing unit 15 of the patient support apparatus 1 is so designed as to compare the sensor value with a threshold value and to initiate the triggering of a safety mode if the threshold value is exceeded. This is effected e.g. by transmitting a signal from the processing unit 15 to the regulating unit 7. In this case, the signal contains e.g. an instruction by means of which the regulating unit 7 can be addressed and whereby the safety mode can be triggered. The processing unit 15 itself comprises an arithmetic unit or a programmable control and a memory unit.

The safety mode can disable a mobile mode of the patient support apparatus 1 and/or change an operating mode. If a measured sensor value, i.e. an actual state, exceeds a predefined sensor value, i.e. a threshold value, it may be necessary to discharge the gas mixture from the patient support apparatus 1 immediately, e.g. if the patient support apparatus 1 assumes a shape which would endanger the patient 2. Disabling the mobile mode of the patient support apparatus 1 prevents any further change to the shape of the patient support apparatus 1, e.g. any further supply of a gas mixture, and therefore serves to increase the safety of the patient support apparatus 1. A change in the operating mode of the patient support apparatus 1 causes e.g. an immediate discharge of the gas mixture in the patient support apparatus, and therefore e.g. a return to the initial state of the patient support apparatus 1, and likewise allows greater safety of the patient support apparatus 1.

FIG. 2 shows an exemplary embodiment of a patient support apparatus 1 according to the invention, being an alternative to that shown in FIG. 1, and a medical imaging device 17. Essentially identical components, features and functions are denoted generally by the same reference signs. The following description is limited essentially to the differences relative to the exemplary embodiment in FIG. 1, wherein reference is made to the description of the exemplary embodiment in FIG. 1 in respect of identical components, features and functions.

FIG. 2 shows a medical imaging device 17 comprising a patient support apparatus 1 according to the invention. The medical imaging device 17 has a control unit 18 and the processing unit 15 of the patient support apparatus 1 is at least partly comprised in said control unit 18.

The chamber 4 is adapted to a shape of a bed surface 16 of the examination table 3. It is thus possible to achieve a better fit of the patient support apparatus 1 relative to the bed surface 16 used during an examination, thereby avoiding unevenness, air pockets, etc. The patient support apparatus 1 can also be directly adapted to a multiplicity of existing bed surfaces 16 in this way, e.g. patient beds of medical imaging devices 17, such that use of the patient support apparatus 1 is not limited in the context of a medical examination using older devices.

In summary, the invention relates to a patient support apparatus for supporting a patient on an examination table. The patient support apparatus comprises at least one chamber having at least one opening for supplying a filler, a connection unit for connecting the at least one chamber to a regulating unit, and the regulating unit for regulating a quantity of the filler within the at least one chamber. In a preferred embodiment variant, the patient support apparatus has a pressure sensor for capturing a sensor value of a pressure, and a processing unit which is so designed as to compare the sensor value with a threshold value.

We claim:

1. A patient support apparatus for supporting a patient on an examination table, comprising:
a chamber having an opening for supplying a filler;
a connection unit for connecting the chamber to a regulating unit; and
the regulating unit for regulating a quantity of the filler within the chamber.

2. The patient support apparatus as claimed in claim 1, wherein the filler comprises a gas and gas mixture.

3. The patient support apparatus as claimed in claim 1, wherein the filler comprises a gas or gas mixture.

4. The patient support apparatus as claimed in claim 1, wherein the regulating unit has a pump for supplying the filler.

5. The patient support apparatus as claimed in claim 1, wherein the chamber has a discharge valve for discharging the filler.

6. The patient support apparatus as claimed in claim 1, wherein the chamber comprises an elastic covering.

7. The patient support apparatus as claimed in claim 1,
wherein the patient support apparatus has an equalization container for fillers, and
wherein the chamber includes an interface by means of which the chamber is attached to the equalization container.

8. The patient support apparatus as claimed in claim 7, wherein the equalization container for fillers is equipped with a spring-loaded piston.

9. The patient support apparatus as claimed in claim 1, further comprising at least two chambers, which are so arranged as to be mutually independent or interconnected in each case.

10. The patient support apparatus as claimed in claim 1, further comprising a pressure sensor for capturing a sensor value of a pressure.

11. The patient support apparatus as claimed in claim 1, wherein the patient support apparatus includes a shape sensor for capturing a sensor value of a geometric shape of the chamber.

12. The patient support apparatus as claimed in claim 10, further comprising a processing unit, which is so designed as to compare the sensor value with a threshold value.

13. The patient support apparatus as claimed in claim 12, wherein the processing unit is so configured as to trigger a safety mode when the threshold value is exceeded.

14. The patient support apparatus as claimed in claim 13, wherein the safety mode disables a mobile mode of the patient support apparatus and changes an operating mode of the patient support apparatus.

15. The patient support apparatus as claimed in claim 13, wherein the safety mode disables a mobile mode of the patient support apparatus or changes an operating mode of the patient support apparatus.

16. The patient support apparatus as claimed in claim 1, wherein the chamber is adapted to a shape of a bed surface of the examination table.

17. A medical imaging device, comprising:
a patient support apparatus as claimed in claim 1.

18. The medical imaging device as claimed in claim 17, further comprising a control unit, and
wherein the processing unit of the patient support apparatus is at least partly comprised in the control unit.
